(19) United States
(12) Patent Application Publication
(10) Pub. No.: US 2005/0173850 A1
(43) Pub. Date: Aug. 11, 2005

(54) Linear electric motor assisted gas spring

(76) Inventors: Mark M. Rose, Myrtle Beach, SC (US); Jack R. Roach, Florence, SC (US); Walter Douglas Bauman, Wixom, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/393,157

(22) Filed: Mar. 20, 2003

(51) Int. Cl. F16F 5/00

(52) U.S. Cl. 267/64.12

(57) ABSTRACT

A gas spring assembly includes a gas spring and a linear electric motor which assists in operation of the gas spring. A coil assembly for a linear electric motor is mounted to a body of the gas spring. The coil assembly generates a magnetic field which interacts with a magnet mounted to a piston. Driving the magnet within an electric field assists in driving the piston of the gas spring. To assist in operation of the gas spring while reducing the packaging space of the gas spring.

### BACKGROUND OF THE INVENTION

The present invention relates to a gas spring, and more particularly to a gas spring utilizing a linear electric motor assist.

Biasing members known as pneumatic or gas springs, which for convenience can be referred to as counterbalance links are becoming more and more common in commercial articles, particularly in the automotive industry, but they are being used in many other fields wherever the need is present to provide a counterbalance force for closure units, such as lids, doors and cabinet fronts. Gas spring replacement for mechanical spring fittings is also becoming prevalent. In the automotive field, for example, pneumatic springs are used to assist in opening and supporting trunk lids and lift gates. In such applications, the counterbalance spring assemblies are compressed when the lid is closed, and they extend under differential pressure force acting on the piston when the lid is opened.

In many of applications, a relatively high internal cylinder pressure is required to cause the spring to extend. These high operating pressures impose stringent sealing requirements for the pneumatic spring components which may add to the complexity of the manufacturing process.

Accordingly, it is desirable to provide a gas spring which includes an assist mechanism to increase the effectiveness of the gas spring without greatly increasing the packaging space required.

### SUMMARY OF THE INVENTION

The gas spring assembly according to the present invention provides a gas spring and a linear electric motor which assists operation of the gas spring.

A gas spring assembly has a main body and piston. A coil assembly for a linear electric motor is mounted to the gas spring to generate a magnetic field which interacts with a magnet pack mounted to the piston. When the linear electric motor is activated the force created by the magnet pack will assist in starting the piston in motion. As the piston and magnet pack approach the full compression or extension position the magnetic field created by the coil assembly is switched to drive the magnet pack in an opposite direction. Ending motion of the piston is also cushioning by reversing the magnet pack when the piston reaches the end of travel.

The present invention therefore provides a spring assembly where a linear electric motor assist in performing the work and is efficiently packaged.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a diagrammatic view of a gas spring installed on a moveable closure member showing three positions of the counterbalance;

FIG. 2 is a longitudinal sectional through a gas spring designed according to the present invention; and

FIG. 3 is a longitudinal sectional through a gas spring according to an alternate embodiment of the present invention.

### DETAILED DESCRIPTION OF THE PREFERRED EMBODIMENT

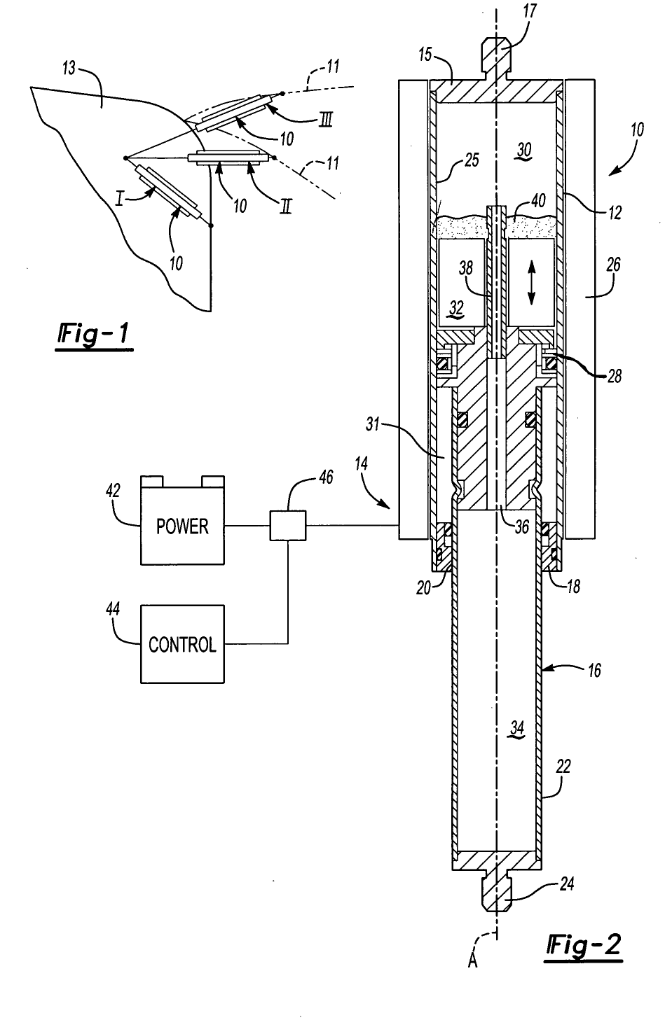

FIG. 1 illustrates a general view of a gas spring assembly 10 designated as a counterbalance link. The gas spring assembly 10 is schematically illustrated in an intermediate position (II) between a compressed condition (I) and an extended condition (III) as an example of a counterbalance for a moveable closure member 11 of a vehicle 13. The gas spring assembly 10 may, of course, be used in many other applications. A linear electric motor 14 is used to assist in compressing, extending, and cushioning the gas spring assembly 10.

Referring to FIG. 2, the gas spring assembly 10 includes the linear electric motor 14 and a gas spring 16. The gas spring 16 includes a main body 12 which is preferably cylindrical. The body 12 has a closed end 15 on which is mounted an attachment fixture (illustrated schematically at 17). The opposite end of the main body 12 is closed off by an end plug 18 which defines an aperture 20 to allow linear passage of a piston rod 22 along a gas spring axis A. The piston rod 22 includes an attachment fixture (illustrated schematically at 24). It should be understood that various attachment fixtures such as fixed threaded connections and movable connections such as ball joints will benefit from the present invention.

The linear electric motor 14 includes a coil assembly 26 which is mounted to the gas spring 16. The linear electric motor 14 produces a linear force assisting the gas spring 16 in operation. As the body 12 is cylindrical, the coil assembly 26 is tubular to best fit around the main body 12. Other complementary geometries for the body 12 and coil 26 will also benefit from the present invention. The body 12 and/or piston rod 22 are preferably made of a non-magnetic material so as not to interfere with the functioning of the linear electric motor 14.

Within the body 12, the piston rod 22 is attached to a piston 28. Assembly of the piston rod 22 within the body 12 forms a main chamber 30. Within the body 12, the piston rod 22 is attached to a piston 28 which engages an inner wall 25 of the body 12 to separate the body 12 into a main chamber 30 and an outer chamber 31. The piston 28 operates as a check valve and orifice by-pass structure to provide controlled by-pass flow of gas between chambers 30 and 31. There is a relatively free flow by-pass provided during the retraction or compression stroke and an “orifice” metered flow of gas past the piston 28 during the extension or expansion stroke. It should be understood that piston 28 may include various well-known porting, passageway and/or valve arrangements which provide for gas and oil transfer between chambers 30 and 31 as the piston rod 22 telescopes inward and outward relative to the body 12.

A magnet pack 32 for the linear electric motor 14 is mounted to the piston 28. The magnet pack 32 is preferably mounted so that it is within the main chamber 30. During the compression and expansion stroke the piston 28 moves relative to the body 12. As the piston 28 moves, the size of the main chamber 30 varies. As is known, a high pressure within the main chamber 30 is required to generate the force necessary for the gas spring 16 to operate. The linear electric motor 14 assists the gas pressure in movement of the piston 28 by increasing the force generated during motion. Alternately or in addition, a lower gas pressure may be utilized in combination with the linear electric motor 14 to provide a gas spring assembly 10 of equivalent load capabilities.

The piston rod 22 may be hollow in order to compensate for the volume of the main chamber 30 which is used by the magnet pack 32. A piston chamber 34 is formed within the piston rod 22 and an internal aperture 36 connects the main chamber 30 to the piston chamber 34. The internal aperture 36 preferably mounts a tubular member 38 which extends along the gas spring axis A to prevent a liquid oil 40 contained within the main chamber 30 from entering the piston chamber 34 of the piston rod 22 when the piston rod 22 is rotated to a downward position as illustrated in FIG. 2. A pre-determined quantity of the liquid oil 40 is contained within the main chamber 30 prior to assembly to provide lubrication and liquid for damping at the end of the expansion stroke as generally known. The magnet pack 32 is preferably affixed to the piston 28 around the tubular member 38.

A power source 42 is attached to the coil assembly 26. A controller 44 is used to turn on the power source 42 which generates a current through the coil assembly 26. The current running through the coil assembly 26 generates a magnetic field. The magnetic field drives the magnet pack 32 and the piston 28 along the gas spring axis A to assist compression and extension of the gas spring assembly 10.

Additionally, if the piston 28 is in a resting position, initiation of movement by an external source such as manual initiation by an operator may be utilized as a signal for the controller 44 to initiate generation of the magnetic field. Generating the magnetic field will drive the magnet pack 32 along the gas spring axis A. The force created by the magnet pack 32 will assist in starting the piston 28 in motion.

The piston 28 has momentum in the direction of travel along the gas spring axis A. As the piston 28 and magnet pack 32 approach the full compression or extension position the controller 44 activates a switch 46 which changes the direction of current running through the coil assembly 26. Switching the direction of the current switches the direction of the magnetic field. That is, the poles on the magnetic field are exchanged. Exchanging the poles causes the magnetic field to repel the magnet pack 32 along the gas spring axis A. During this time the opposing forces of the piston 28 and magnet pack 32 will slow the compression or extension of the gas spring assembly 10. Thus, the linear electric motor 14 assists in cushioning the end of travel of the gas spring assembly 10.

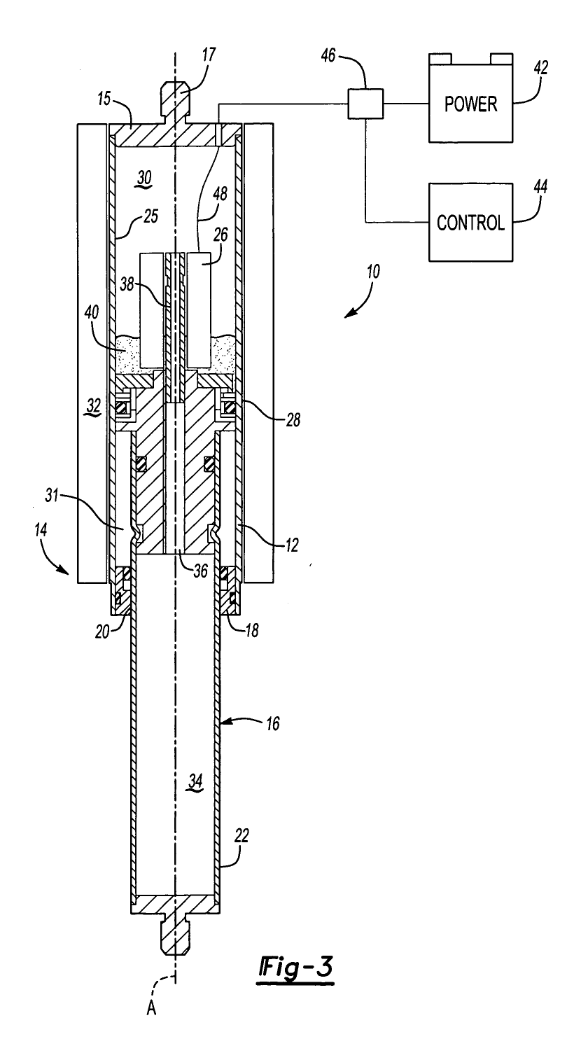

Referring to FIG. 3, the gas spring 16 and linear motor assembly 14 may also be arranged such that the magnet pack 32 is mounted around the body 12 and the coil assembly 26 is mounted internally, to the piston 28. The coil assembly 26 moves with the piston 28 during operation of the gas spring assembly 10. Wires 48 for connecting the coil to the power source 42, controller 44, and switch 46 preferably includes a coil or other extension/retraction feature to allow movement of the piston 28.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1-23. (canceled)

24. A gas spring assembly comprising:
a piston and a cylinder, one of said piston and said cylinder adapted to be attached to a vehicle, and the other of said piston and said cylinder adapted to be attached to a movable closure on the vehicle;
a fluid received within said cylinder to control movement of said piston within said cylinder, which in turn controls movement of the movable closure;
a magnetic drive for assisting in relative movement between said piston and said cylinder; and
a control that detects a beginning of movement of said piston relative to said cylinder in a first direction, and provides a magnetic force assisting said movement by driving said piston relative to said cylinder in said first direction.

25. The gas spring assembly as set forth in claim 24, including a coil surrounding said cylinder and a magnet mounted for movement with said piston.

26. The gas spring assembly as set forth in claim 24, wherein said control further reverses a direction of said magnetic force as said piston and said cylinder approach an end of stroke position to slow movement of said piston relative to said cylinder near said end of stroke position.

27. The gas spring assembly as set forth in claim 24, wherein said piston includes a valve such that fluid flow is more restricted in one direction of movement of said piston relative to said cylinder, and is less restricted in an opposed direction of movement of said piston relative to said cylinder.

28. The gas spring assembly as set forth in claim 27, wherein said one direction is defined as an expansion stroke of said piston outwardly of said cylinder.

29. A vehicle closure comprising:
a vehicle body having an opening selectively closed by a closure;
at least one gas spring having a piston and a cylinder, one of said piston and said cylinder attached to said vehicle body, and the other of said piston and said cylinder attached to said closure, and a fluid received within said cylinder to control movement of said piston within said cylinder, which in turn controls movement of said closure;
a magnetic drive for assisting in relative movement between said piston and said cylinder; and
a control that detects a beginning of movement of said piston relative to said cylinder in a first direction, and provides a magnetic force assisting said movement by driving said piston relative to said cylinder in said first direction.

30. The vehicle closure as set forth in claim 29, including a coil surrounding said cylinder and a magnet mounted for movement with said piston.

31. The vehicle closure as set forth in claim 29, wherein said control further reverses a direction of said magnetic force as said piston and said cylinder approach an end of stroke position to slow movement of said piston relative to said cylinder near said end of stroke position.

32. The vehicle closure mount as set forth in claim 29, wherein said piston includes a valve such that fluid flow is more restricted in one direction of movement of said piston relative to said cylinder, and is less restricted in an opposed direction of movement of said piston relative to said cylinder.

33. The vehicle closure mount as set forth in claim 32, wherein said one direction is defined as an expansion stroke of said piston outwardly of said cylinder.

34. A gas spring assembly comprising:
a piston and a cylinder, one of said piston and said cylinder adapted to be attached to a vehicle, and the other of said piston and said cylinder adapted to be attached to a movable closure on the vehicle;
a fluid received within said cylinder to control movement of said piston within said cylinder, which in turn controls movement of the movable closure;
a magnetic drive for assisting in relative movement between said piston and said cylinder through a stroke; and
a control that detects an approaching end of stroke position of said piston relative to said cylinder in a first direction, and provides a magnetic force resisting movement of said piston relative to said cylinder to slow movement of said piston relative to said cylinder near said end of stroke position.
